(19) United States
(12) Patent Application Publication
(10) Pub. No.: US 2015/0337241 A1
(43) Pub. Date: Nov. 26, 2015

(54) THICKENED AQUEOUS DETERGENT LIQUID

(71) Applicant: Conopco, Inc., d/b/a UNILEVER, Englewood Cliffs, NJ (US)

(72) Inventors: Adam Peter Jarvis, Bebington (GB); Adam John Limer, Bebington (GB); Philip Michael Ryan, Bebington (GB); Matthew Rhys Thomas, Bebington (GB)

(73) Assignee: Conopco, Inc. d/b/a UNILEVER, Englewood Cliffs, NJ (US)

(21) Appl. No.: 14/647,693

(22) PCT Filed: Nov. 25, 2013
(86) PCT No.: PCT/EP2013/074596

§ 371 Date: May 27, 2015

(30) Foreign Application Priority Data
Nov. 29, 2012 (CN) PCT/CN2012/085567

(51) Int. Cl. C11D 3/37; C11D 1/22

(52) U.S. Cl. CPC C11D 3/3765; C11D 1/22

(57) ABSTRACT

A thickened aqueous detergent liquid comprising: (i) at least 5 wt % of a surfactant system comprising anionic surfactant, (ii) at least 0.2 wt % of a thickening system comprising a linear copolymer formed by the addition polymerisation of: (A) 0.1 to 5 wt % of a first monomer consisting of an ethylenically unsaturated diacid of formula (I): HOOC—CR₁═CR₂—COOH (I) or an unsaturated cyclic anhydride precursor of such an ethylenically unsaturated diacid, the anhydride having formula (II), where R₁ and R₂ are individually selected from H, C₁-C₃ alkyl, phenyl, chlorine and bromine; (B) 15 to 60 wt % of a second ethylenically unsaturated monoacidic monomer consisting of (meth)acrylic acid; (C) 30 to 70 wt % of a third ethylenically unsaturated monomer consisting of C₁-C₈ alkyl ester of (meth)acrylic acid; (D) 1 to 25 wt %, of a fourth ethylenically unsaturated monomer, consisting of surfmer of formula (III), wherein each R₃ and R₄ are each independently selected from H, methyl, —C(═O)OH, or —C(═O)OR₅; R₅ is a C₁-C₃₀ alkyl; T is —CH₂C(═O)O—, —C(═O)O—, —O—, —CH₂O—, —NHC(═O)NH—, —C(═O)NH—, —Ar—(CE₂)_{z}—NHC(═O)O—, —Ar—(CE₂)_{z}—NHC(═O)NH—, or CH₂CH₂NHC(═O)—Ar is divalent aryl; E is H or methyl; z is 0 or 1; k is an integer in the range of 0 to 30; and m is 0 or 1; with the proviso that when k is 0, m is 0, and when k is in the range of 1 to 30; m is 1; (R₆O)ₙ is polyoxyalkylene, which is a homopolymer, a random copolymer, or a block copolymer of C2-C4-oxyalkylene units, wherein R₆ is C₂H₄, C₃H₆, C₄H₈, or a mixture thereof, and n is an integer in the range of 5 to 250; Y is —R₆O—, —R₆—, —C(═O)—, —C(═O)NH—, ═R₆NHC(═O)NH—, or —C(═O)NHC(═O)—; and R₇ is substituted or unsubstituted alkyl selected from the group consisting of C₈-C₄₀ linear alkyl, C₈-C₄₀ branched alkyl, C₈-C₄₀ carbocyclic alkyl, C₂-C₄₀ alkyl-substituted, phenyl, aryl-substituted C₂-C₄₀ alkyl, and C₈C₈₀ complex ester; wherein the R₇ alkyl group optionally comprises one or more substituents selected from the group consisting of hydroxy, alkoxy, and halogen.

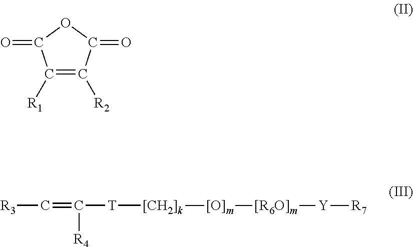

### TECHNICAL FIELD

This invention relates to aqueous detergent compositions comprising an alkali swellable acrylic based rheology modifying polymer emulsion with hydrophobic modification, or HASE polymer.

### BACKGROUND

A trend in detergent formulating is to reduce the amount of surfactant and to replace these petrochemical derived ingredients with highly weight efficient ingredients selected from cleaning and soil release polymers, sequestrants and enzyme cocktails. Typically some surfactant is retained in the composition and the work horse surfactant linear alkyl benzene sulphonate (LAS) is frequently a key part of the surfactant blend. The polymer ethoxylated polyethylene imine may be used as one of the weight efficient ingredients. Suitable compositions are taught, for example, in WO09153184.

It has been found that consumers prefer that the new type of concentrated liquid is thickened so that it conveys the impression of high contents when in the bottle. On the other hand it is desirable that the pour viscosity is low enough that dosing can be done easily and accurately. A shear thinning composition is thus desired.

Hydrophobically modified alkali swellable emulsion (HASE) copolymers are a type of synthetic associative thickener. This thickener typically contains a backbone consisting of randomly distributed methacrylic acid (MAA) and ethylacrylate (EA) monomers.

Inserted into this backbone are a small proportion of hydrophobically modified groups, usually less than 3 mol %. The monomers to form these hydrophobic groups are sometimes referred to as surfmers or associative monomers. Due to its structure, the copolymer, when dissolved in an alkaline aqueous liquid, induces a variety of interacting forces such as hydrophobic, hydrogen bonding, electrostatic, etc and this modifies the rheology of the liquid.

HASE copolymers are usually synthesized via the emulsion polymerization technique.

U.S. Pat. No. 5,015,711 (Coatex) discloses a thickening terpolymer of the MAA/EA/surfmer type. U.S. Pat. No. 5,015,711 makes the following disclosure: “The first type of monomer, which is a carboxylic acid with an ethylenic unsaturation site, is a C₃-C₂₀, preferably C₃-C₁₂, compound having an ethylenic bond and at least one carboxylic group or a carboxylic acid anhydride group. The carboxylated ethylenic monomer can be selected from among monoacids, such as acrylic acid, methacrylic acid, crotonic acid, isocrotonic acid, cinnamic acid, diacids, such as itaconic acid, fumaric acid, maleic acid, and citraconic acid, carboxylic acid anhydrides, such as maleic anhydride and diacid hemiesters, such as the C₁₋₄ monoesters of maleic or itaconic acids. However, the carboxyl ethylene monomer is preferably selected from the group consisting of acrylic acid, methacrylic acid and itaconic acid”.

U.S. Pat. No. 4,384,096 discloses a copolymer having 42% MAA, 6% IA, 42% EA and 10% surfmer (where IA is itaconic acid). The surfmer used was Nonylphenoxy poly(ethyleneoxy)₉ ethyl Methacrylate. U.S. Pat. No. 4,384,096 contains a general disclosure relating to the use of Itaconic acid as follows: “Acrylic or methacrylic acid or a mixture thereof with itaconic or fumaric acid are preferred, but crotonic and aconitic acid and half esters of these and other polycarboxylic acids such as maleic acid with C₁-C₄ alkanols are also suitable, particularly if used in minor amount in combination with acrylic or methacrylic acid”. The itaconic acid containing polymer was not tested for its pH response.

The manufacture of LAS-containing liquid detergent compositions, for example compositions intended for laundry or hard surface cleaning applications, typically entails the neutralisation of the corresponding alkylbenzene sulphonic acid with base. During the manufacturing process a very high pH composition may temporarily be formed. We have found that when some HASE polymers are exposed to a pH above about 10 they may no longer function efficiently. The detergent formulator would like to be able to have freedom to use manufacturing processes where the pH may temporarily rise above 10. It is thus an objective to find thickening polymer that can be neutralised along with the surfactant and which can function efficiently even if it is temporarily exposed to a pH of more than 10 during processing.

### SUMMARY OF THE INVENTION

According to the present invention there is provided a thickened aqueous detergent liquid comprising:
(i) at least 5 wt % of a surfactant system comprising anionic surfactant,
(ii) at least 0.2 wt % of a thickening system comprising a linear copolymer formed by the addition polymerisation of:
   (A) 0.1 to 5 wt % of a first monomer consisting of an ethylenically unsaturated diacid of formula (I):

HOOC—CR₁═CR₂—COOH (I)
or an unsaturated cyclic anhydride precursor of such an ethylenically unsaturated diacid, the anhydride having formula (II)

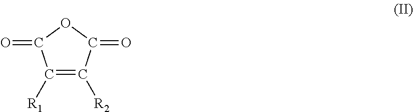

where R₁ and R₂ are individually selected from H, C₁-C₃ alkyl, phenyl, chlorine and bromine;
(B) 15 to 60 wt % of a second ethylenically unsaturated monoacidic monomer consisting of (meth)acrylic acid;
(C) 30 to 70 wt % of a third ethylenically unsaturated monomer consisting of C₁-C₈ alkyl ester of (meth)acrylic acid; and
(D) 1 to 25 wt %, of a fourth ethylenically unsaturated monomer, consisting of surfmer of formula (III):

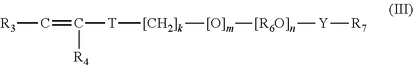

wherein each R₃ and R₄ are each independently selected from H, methyl, —C(═O)OH, or —C(═O)OR₅;
R₅ is a C₁-C₃₀ alkyl;
T is —CH₂C(═O)O—, —C(═O)O—, —O—, —CH₂O—, —NHC(═O)NH—, —C(═O)NH—, —Ar—(CE₂)_{z}—NHC(═O)O—, —Ar—(CE₂)_{z}—NHC(═O)NH—, or —CH₂CH₂NHC(═O)—;
Ar is divalent aryl;
E is H or methyl;
z is 0 or 1;
k is an integer in the range of 0 to 30; and m is 0 or 1; with the proviso that when k is 0, m is 0, and when k is in the range of 1 to 30; m is 1;
(R₆O)ₙ is polyoxyalkylene, which is a homopolymer, a random copolymer, or a block copolymer of C₂-C₄-oxyalkylene units, wherein R₆ is C₂H₄, C₃H₆, C₄H₈, or a mixture thereof, and n is an integer in the range of 5 to 250; Y is —R₆O—, —R₆—, —C(═O)—, —C(═O)NH—, ═R₆NHC(═O)NH—, or —C(═O)NHC(═O)—; and
R₇ is substituted or unsubstituted alkyl selected from the group consisting of C₈-C₄₀ linear alkyl, C₈-C₄₀ branched alkyl, C₈-C₄₀ carbocyclic alkyl, C₂-C₄₀ alkyl-substituted, phenyl, aryl-substituted C₂-C₄₀ alkyl, and C₈-C₈₀ complex ester; wherein the R₇ alkyl group optionally comprises one or more substituents selected from the group consisting of hydroxy, alkoxy, and halogen.
Preferably Surfmer D has the formula (IV)

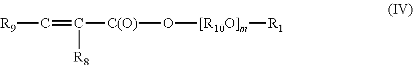

where:
R₈ and R₉ are each independently selected from H, and C₁₋₃ alkyl;
R₁₀ is C₂-C₄ and mixtures thereof, preferably C₂;
m, the average number of alkoxy units R₁₀O, is from 6 to 40;
R₁₁ is alkyl or alkylaryl where the alkyl part is linear or branched; and
the total number of carbons is from 10 to 40.

In this specification the term (meth)acrylic acid includes both acrylic acid and methacrylic acid and the term (meth)acrylate includes both acrylate and methacrylate.

The viscosity of the liquid at 20 s⁻¹ and 25° C. is preferably at least 0.3 Pa·s, most preferably at least 0.4 Pa·s.

The compositions preferably comprise at least 1 wt % of the copolymer (ii).

Copolymer (ii) preferably has a molecular weight Mw of over 250 000, more preferably over 500 000 Daltons.

The copolymers (ii) are linear, that is uncrosslinked, alkali swellable hydrophobically modified acrylic copolymers, HASE. These polymers require alkaline conditions to swell and so should be added to the composition such that they are exposed to alkaline conditions at some stage during the manufacture of the detergent liquid.

In order to provide maximum charge density and improved swelling it is preferred to use maleic acid as the diacid (A) in copolymer (ii). Conveniently maleic anhydride is used as the first monomer A in the copolymerisation.

Also according to the invention there is provided a process for manufacture of a detergent composition, the process comprising mixing a linear HASE copolymer formed from Monomers A, B C and D as described above with an acid precursor of an anionic surfactant and then adding alkali sufficient to neutralise the surfactant acid and to swell the copolymer.

### DETAILED DESCRIPTION OF THE INVENTION

### First Monomer A

The copolymer is formed using a monomer A which may ring open to form a diacidic unit in the polymer. Diacidic unit means that carboxylate groups are attached to adjacent carbon atoms in the carbon backbone of the copolymer. Conveniently this unit is formed from a cyclic ethylenically unsaturated anhydride monomer of formula (II). It is preferred that monomer A is such an anhydride.

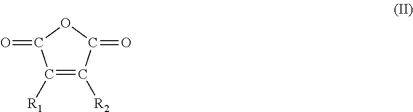

where R₁ and R₂ are individually selected from H, C₁-C₃ alkyl, phenyl, chlorine and bromine. Use of a cyclic anhydride monomer with ethylenic unsaturation gives a cis diacid if the ring opens. Such a diacid has both carboxylate groups arranged on the same side of the polymer but on different carbon atoms.

Preferably R₁ is hydrogen and R₂ is selected from the group comprising hydrogen, methyl, bromine and phenyl. More preferably R₁ is hydrogen and R₂ is selected from hydrogen and methyl. Most preferably R₁ and R₂ are hydrogen so that the anhydride is maleic anhydride. This is the precursor for maleic acid. It is thought that because maleic acid produces carboxylate groups on adjacent carbon atoms in the polymer backbone this increases the localised charge density and causes the difference in performance compared with copolymers not containing this diacid. Itaconic acid which is outside the scope of this invention provides a polymer element where one carbon carries two carboxylate groups and the other carries none. Fumaric acid is the trans isomer of maleic acid it cannot be formed from maleic anhydride monomer by hydrolysis during the emulsion polymerization.

Monomer A may range from 0.1 to 5 wt %, preferably from 0.2 to 4 wt %, and more preferably from 0.3 to 1 wt %, and optimally from 0.4 to 0.6 wt % of the total copolymer.

### Second Monomer B

The second monomer B is a monoacidic vinyl monomer. Suitable monomers are acrylic acid, methacrylic acid, salts of the aforementioned acids and combinations thereof.

In the compositions, the acid groups may be neutralized to form salts. Typical salt counterions to the acid groups are sodium, potassium, ammonium and triethanolammonium cations.

Amounts of the monoacidic vinyl monomer in the copolymers may range from 15 to 60 wt %, preferably from 20 to 55 wt %, more preferably from 25 to 50 wt % of the total copolymer.

### Third Monomer C

The third monomer, C, includes one or more C₁-C₈ esters of acrylic or methacrylic acid. Illustrative ester monomers are ethylacrylate, methylacrylate, ethylmethacrylate, methylmethacrylate, butylacrylate, butylmethacrylate and mixtures thereof. Ethyl acrylate is most preferred.

The amount of acrylate ester monomers in the copolymer may range from 30 to 70 wt %, preferably from 25 to 60 wt %, and more preferably from 40 to 65 wt % of the total copolymer.

### Fourth Monomer D

The fourth ethylenically unsaturated monomer, consists of a surfmer of formula (III):

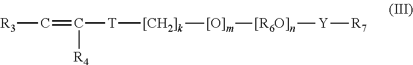

wherein
R₃ and R₄ are each independently selected from H, methyl, —C(═O)OH, or —C(═O)OR₅; and R₅ is a C₁-C₃₀ alkyl;
T is —CH₂C(═O)O—, —C(═O)O—, —O—, —CH₂O—, —NHC(═O)NH—, —C(═O)NH—, —Ar—(CE₂)_{z}—NHC(═O)O—, —Ar—(CE₂)_{z}—NHC(═O)NH—, or —CH₂CH₂NHC(═O)—;
Ar is divalent aryl;
E is H or methyl;
z is 0 or 1;
k is an integer in the range of 0 to 30; and m is 0 or 1;
with the proviso that when k is 0, m is 0, and when k is in the range of 1 to 30; m is 1;
(R₆O)ₙ is polyoxyalkylene, which is a homopolymer, a random copolymer, or a block copolymer of C₂-C₄-oxyalkylene units, wherein R₆ is C₂H₄, C₃H₆, C₄H₈, or a mixture thereof, and n is an integer in the range of 5 to 250; Y is —R₆O—, —R₆—, —C(═O)—, —C(═O)NH—, ═R₆NHC(═O)NH—, or —C(═O)NHC(═O)—; and
R₇ is substituted or unsubstituted alkyl selected from the group consisting of C₈-C₄₀ linear alkyl, C₈-C₄₀ branched alkyl, C₈-C₄₀ carbocyclic alkyl, C₂-C₄₀ alkyl-substituted, phenyl, aryl-substituted C₂-C₄₀ alkyl, and C₈-C₈₀ complex ester; wherein the R₇ group optionally comprises one or more substituents selected from the group consisting of hydroxy, alkoxy, and halogen.
Preferably Surfmer D has the formula (IV)

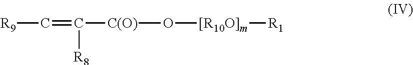

where:
R₈ and R₉ are each independently selected from H, and C₁₋₃ alkyl;
R₁₀ is C₂-C₄ and mixtures thereof, preferably C₂;
m, the average number of alkoxy units R₁₀O, is from 6 to 40;
R₁₁ is alkyl or alkylaryl where the alkyl part is linear or branched; and
the total number of carbons is from 10 to 40.

The fourth monomer D is more preferably a surfmer of formula (V).

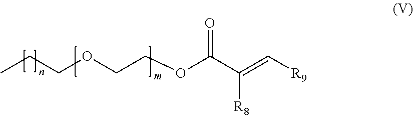

in which each R₈ and R₉ are independently selected from H, C₁ to C₃ alkyl

Preferably R₈ is a methyl group and R₉ is H.

n ranges from 6 to 40 and m ranges from 6 to 40, preferably n ranges from 10 to 30 and m ranges 15 to 35 most preferably n ranges from 12 to 22 and m ranges from 20 to 30. It is preferable that m is greater or equal to n.

The amount of surfmer D in the copolymer may range from 1 to 25 wt %, preferably from 3 to 20 wt %, and more preferably from 2 to a 12 wt % of the total copolymer.

Preferably the level of copolymer in the thickening system is from 0.2 to 3 wt % of the total composition; more preferably from 0.4 to 2 wt %, even 0.5 to 2 wt %

The copolymers may be used with other thickeners to make up the thickening system. Preferred co-thickeners are other thickening polymers and thickening clays.

Preferably the surfactant system comprises at least 3 wt % of anionic surfactant, most preferably the anionic surfactant comprises linear alkyl benzene sulphonate.

Advantageously the composition comprises one or more further polymers that are included in the composition for purposes other than rheology modification. Such further polymers may reduce the viscosity of the compositions and this reduction can be compensated for by the inclusion of the thickening polymer. Preferred further polymers are ethoxylated polyethylene imine and/or polyester soil release polymer. Both of these polymers have been found to thin the detergent compositions. Preferably the detergent liquid further comprises at least 1 wt % ethoxylated polyethylene imine polymer. Most preferably it further comprises at least 0.5 wt % of polyester soil release polymers. More preferably the composition comprises at least 3 wt % of ethoxylated polyethylene imine.

Advantageously the detergent composition comprises an effective amount of at least one enzyme selected from the group comprising, pectate lyase, protease, amylase, cellulase, lipase, mannanase. More advantageously it comprises at least 2 of this group of enzymes even more advantageously at least 3 and most advantageously at least 4 of the enzymes from this group.

The invention will now be further described with reference to the following non-limiting examples and to the drawings which are briefly described as:

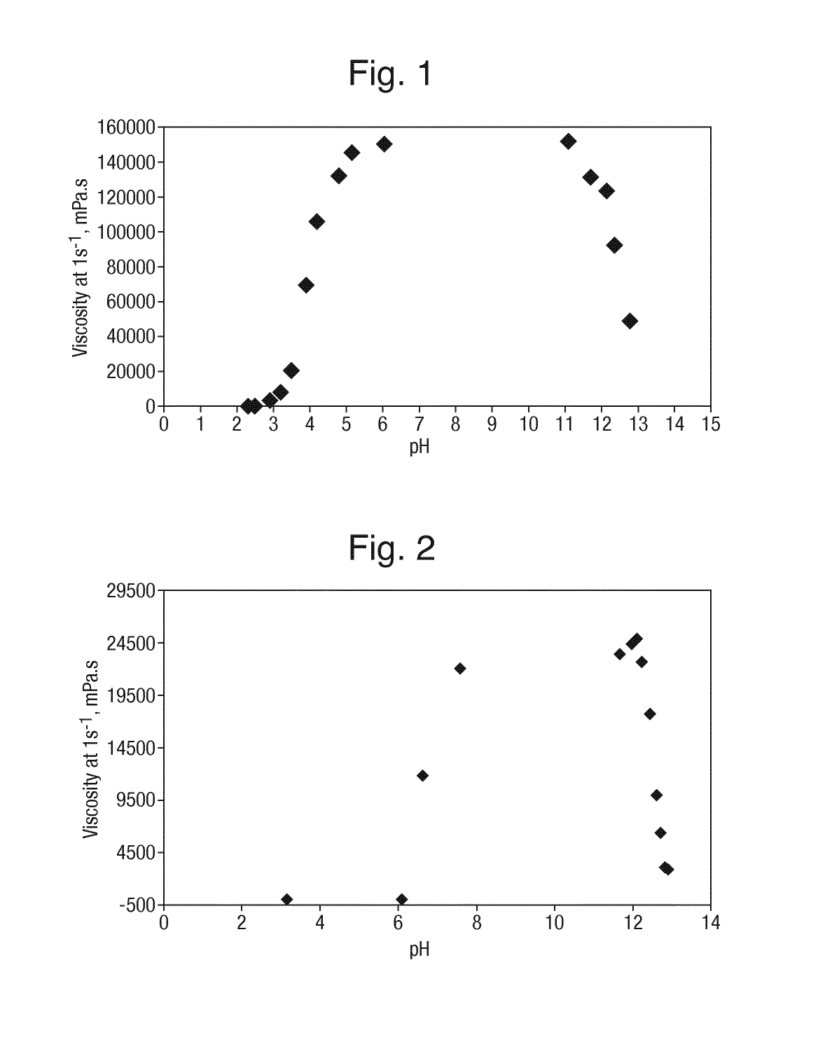

FIG. 1—is a graph showing viscosity changes with pH for Carbopol 980 (a prior art ASE copolymer);

FIG. 2—is a graph showing viscosity changes with pH for Acusol 820 (a prior art HASE copolymer);

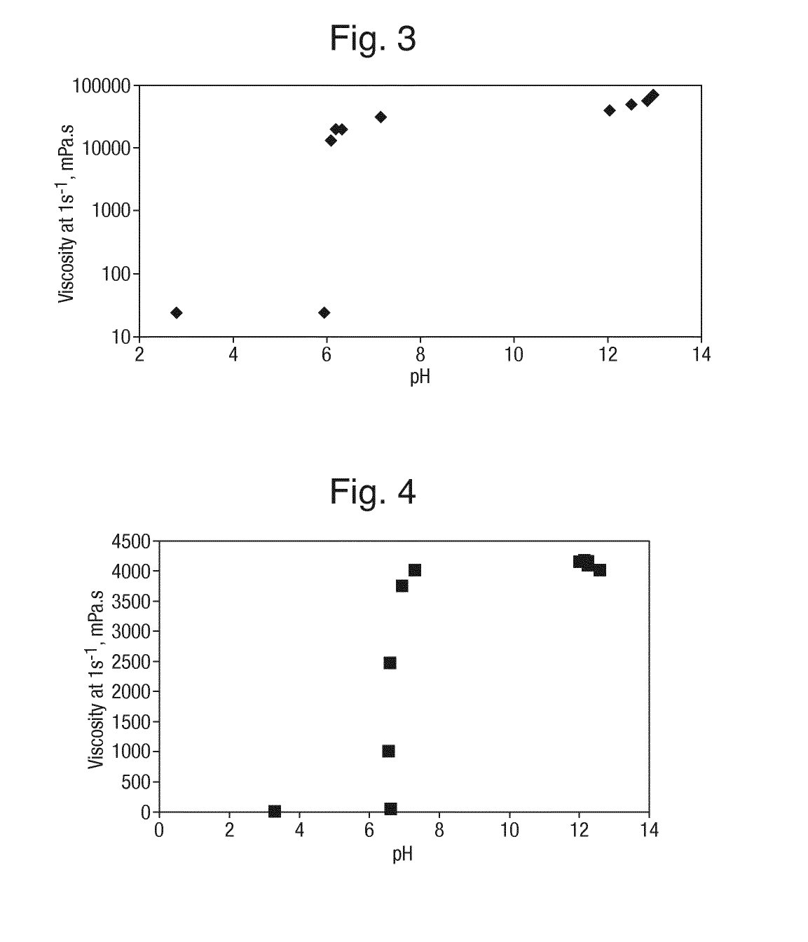

FIG. 3—is a graph showing viscosity changes with pH for a linear HASE Copolymer made using a maleic anhydride monomer; and

FIG. 4—is a graph showing viscosity changes with pH for a further linear HASE copolymer made using a maleic anhydride monomer.

### EXAMPLES

### Surfmer Synthesis

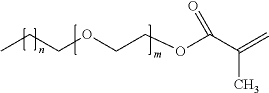 [0082] n=12
m=23

Brij® 35P (150 g) from Sigma Aldrich was dissolved in 500 ml anhydrous dichloromethane under a nitrogen atmosphere and cooled in an ice bath to 5° C. Triethylamine (18.6 g) was added via syringe before methacryloyl chloride (20.9 g) was added dropwise over a 30 minute period. After complete addition, the solution was allowed to warm to room temperature and the reaction stirred for 4 weeks. The solution was then filtered to remove the resulting precipitate and washed once with saturated sodium hydrogen carbonate solution (200 ml) and once with saturated brine (200 ml). The solution was then passed through a column containing basic alumina before the product was dried with anhydrous magnesium sulphate, filtered and the solvent removed in vacuo. In subsequent examples the product is referred to as Surfmer A.

### HASE Copolymer Synthesis

A round bottom flask was charged with ethyl acrylate (EA) (66.8 g), methacrylic acid (MAA) (37.7 g), maleic anhydride (MA) (0.515 g) and Surfmer A (10.0 g). The mixture was sealed and purged with nitrogen for 60 minutes before sodium dodecyl sulfonate (1.03 g) and deoxygenated water (26.5 g) was added and stirred forming a pre-emulsion. A multineck round bottom flask was fitted with a nitrogen sparge and overhead stirrer. Deoxygenated water (181 g) and sodium dodecyl sulfonate (0.298 g) were added, stirred at 250 rpm and heated to 90° C. Ammonium persulfate (0.073 g) in water (1 ml) was added via syringe. The pre-emulsion was fed into the surfactant solution via peristaltic pump over 150 minutes. After complete addition, ammonium persulfate (0.033 g) in water (1 ml) was added and the reaction stirred for a further 240 minutes. The resulting product is hereafter referred to as Copolymer 1. Further Copolymers 2, and 3 were synthesised by using suitable adaptations of this process. All the Copolymers are detailed in Table 1.

TABLE 1

| Polymer | MAA | MA | EA | Surfmer A |
|---|---|---|---|---|
| 1 | 32.8 | 0.45 | 58.1 | 8.7 |
| 2 | 34.6 | 0.47 | 61.4 | 3.5 |
| 3 | 35.2 | 0.58 | 57.7 | 6.5 |

### pH Testing

FIGS. 1 and 2 show how for various known associative thickening polymers the viscosity drops off again at high pH.

FIG. 1 is Carbopol 980 a crosslinked hydrophobically modified (surfmer containing) MMA copolymer. The Copolymer was added to water at 2.9 wt % and then neutralised with NaOH. Allowing time for swelling to occur each time before testing the viscosity of a sample of the thickened liquid using an Anton Paar viscometer. Adding further acid to reduce the pH once the thinning effect commenced at high pH did not increase the viscosity.

FIG. 2 shows another very similar viscosity fall off for a linear hydrophobically modified acrylate copolymer sold by Dow as Acusol 820. The copolymer was added to water at 0.8 wt %, neutralised with NaOH and tested in the same way as for the Carbopol.

FIG. 3 shows the same test done with linear copolymer 1 used at 2.8 wt % and neutralised with NaOH. FIG. 4 shows the same test done with 1 wt % copolymer 3. The reduction of viscosity once a threshold pH is exceeded is not seen for these copolymers made with maleic anhydride.

### Liquid Compositions Using the Copolymers

The alkalinity resistant copolymers give flexibility to the detergent formulator to use manufacturing processes that may expose the copolymers to high pH without fear of loss of rheology as a consequence. They are thus especially useful for compositions which contain anionic surfactants that are normally neutralised during the manufacture of the detergent liquid; thus allowing the heat evolved to be used for assisting with incorporation of other ingredients into the compositions, especially nonionic surfactants.

To test the resilience of the polymer to being added prior to neutralisation of the surfactant acid the aqueous detergent liquid given in Table 2 was made. In this example the polymer is mixed with some of the alkali and the acid added to this mixture before the remainder of the alkali is added. The order of addition of the key ingredients is shown, the remaining ingredients are added once the key ingredients have been mixed and neutralised.

ABLE 2

| | Level (wt %) as | |
|---|---|---|
| Ingredient | 100% active | Order of addition |
| Water | 37.7 | 1 |
| Fluorescer | 0.25 | 2 |
| MPG | 8.0 | 3 |
| Nonionic surfactant | 8.4 | 4 |
| Copolymer 3 | 1.0 | 5 |
| Alkaline Neutraliser (MEA) | 6.2 | 6 |
| Anionic surfactant acid (LAS) | 11.2 | 7 |
| Alkaline Neutraliser (TEA) | 4.0 | 8 |
| Citric acid | 2.5 | |
| Fatty acid | 3.5 | |
| Sequestrant | 1.5 | |
| Anti oxidant | 0.25 | |
| Pre-neutralised Anionic | 8.4 | |
| surfactant (SLES) | | |
| EPEI | 3.0 | |
| Perfume | 1.4 | |
| Opacifier | 0.1 | |
| Enzymes | 2.6 | |

After 8 weeks on store the thickened detergent liquid so produced is still homogeneous and has the following viscosity profile at room temperature shown in Table 3.

TABLE 3

| Shear | Viscosity |
|---|---|
| rate | (mPa · s) |
| 2 s⁻¹ | 389 |
| 21 s⁻¹ | 341 |
| 106 s⁻¹ | 308 |

Some further suitable liquid detergent formulations are given in Table 4 below.

TABLE 4
Exemplary detergent compositions

| Liquid | A | B |
|---|---|---|
| Water | 58.8 | 58.5 |
| LAS | 7.8 | 9.2 |
| SLES | 2.9 | 4.6 |
| Nonionic | 5.5 | 14.0 |
| Fatty acid | 4.5 | 1.5 |
| Alkaline Neutraliser | 8.3 | 2.9 |
| Glycerol | 7.5 | 5.0 |
| MPG | 0.0 | 2.0 |
| Sequestrant | 3.6 | 0.3 |
| HASE copolymer | 0.8 | 0.1 |
| Soil release polymer | 0.1 | 0.0 |
| Enzymes | 0.0 | 0.8 |
| Perfume, colorant and opacifier | 0.6 | 1.5 |
| Fluorescer | 0.0 | 0.1 |
| Preservative and antioxidant | 0.3 | 0.0 |

NB - above inclusion levels are all as 100% active

LAS is linear alkyl benzene sulphonic acid
SLES is sodium lauryl ether sulphate 3EO
EPEI is ethoxylated polyethylene imine PEI(600) 20EO
MPG is Monopropylene glycol
HASE copolymer is Copolymer 1, 2 or 3

1. A thickened aqueous detergent liquid comprising:
(i) at least 5 wt % of a surfactant system comprising anionic surfactant,
(ii) at least 0.2 wt % of a thickening system comprising a linear copolymer formed by the addition polymerisation of:
(A) 0.1 to 5 wt % of a first monomer consisting of an ethylenically unsaturated diacid of formula (I):
HOOC—CR₁═CR₂—COON (I)
or an unsaturated cyclic anhydride precursor of such an ethylenically unsaturated diacid, the anhydride having formula (II) 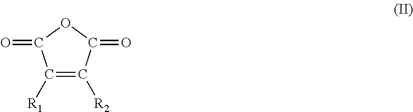
where R₁ and R₂ are individually selected from H, C₁-C₃ alkyl, phenyl, chlorine and bromine;
(B) 15 to 60 wt % of a second ethylenically unsaturated monoacidic monomer consisting of (meth)acrylic acid;
(C) 30 to 70 wt % of a third ethylenically unsaturated monomer consisting of C₁-C₈ alkyl ester of (meth)acrylic acid;
(D) 1 to 25 wt %, of a fourth ethylenically unsaturated monomer, consisting of surfmer of formula (III): 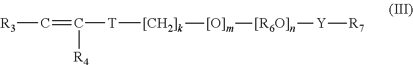
wherein each R₃ and R₄ are each independently selected from H, methyl, —C(═O)OH, or —C(═O)OR₅;
R₅ is a C₁-C₃₀ alkyl;
T is —CH₂C(═O)O—, —C(═O)O—, —O—, —CH₂O—, —NHC(═O)NH—, —C(═O)NH—, —Ar—(CE₂)_{z}—NHC(═O)O—, —Ar—(CE₂)_{z}—NHC(═O)NH—, or —CH₂CH₂NHC(═O)—;
Ar is divalent aryl;
E is H or methyl;
z is 0 or 1;
k is an integer in the range of 0 to 30; and m is 0 or 1; with the proviso that when k is 0, m is 0, and when k is in the range of 1 to 30; m is 1;
(R₆O)ₙ is polyoxyalkylene, which is a homopolymer, a random copolymer, or a block copolymer of C₂-C₄-oxyalkylene units, wherein R₆ is C₂H₄, C₃H₆, C₄H₈, or a mixture thereof, and n is an integer in the range of 5 to 250; Y is —R₆O—, —R₆—, —C(═O)—, —C(═O)NH—, ═R₆NHC(═O)NH—, or —C(═O)NHC(═O)—; and
R₇ is substituted or unsubstituted alkyl selected from the group consisting of C₈-C₄₀ linear alkyl, C₈-C₄₀ branched alkyl, C₈-C₄₀ carbocyclic alkyl, C₂-C₄₀ alkyl-substituted, phenyl, aryl-substituted C₂-C₄₀ alkyl, and C₈-C₈₀ complex ester; wherein the R₇ alkyl group optionally comprises one or more substituents selected from the group consisting of hydroxy, alkoxy, and halogen.

2. A composition according to claim 1 wherein fourth monomer D is a Surfmer with formula (IV): 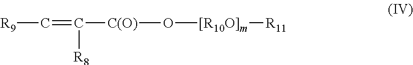
where:
R₈ and R₉ are each independently selected from H, and C₁₋₃ alkyl;
R₁₀ is C₂-C₄ and mixtures thereof, preferably C₂;
m, the average number of alkoxy units R₁₀O, is from 6 to 40;
R₁₁ is alkyl or alkylaryl where the alkyl part is linear or branched; and the total number of carbons is from 10 to 40.

3. A composition according to claim 1 wherein the fourth monomer D is a Surfmer with formula (V): 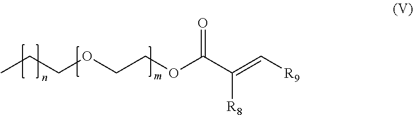
in which each R₈ and R₉ are independently selected from H, C₁ to C₃ alkyl, preferably R₈ is a methyl group and R₉ is H, n ranges from 6 to 40 and m ranges from 6 to 40, preferably n ranges from 10 to 30 and m ranges 15 to 35 most preferably n ranges from 12 to 22 and m ranges from 20 to 30.

4. A composition according to claim 1 wherein the viscosity of the liquid at 20 s⁻¹ and 25° C. is at least 0.3 Pa·s, preferably at least 0.4 Pa·s.

5. A composition according to claim 1 comprising at least 0.4 wt % of the copolymer (ii).

6. A composition according to claim 1 wherein the anionic surfactant is selected from the group consisting of alkyl benzene sulphonate, and alkyl sulphate.

7. A composition according to claim 1 wherein the anionic surfactant comprises linear alkyl benzene sulphonate, sodium salt.

8. A composition according to claim 1 wherein the composition further includes a viscosity reducing polymer selected from ethoxylated polyethylene imine and polyester soil release polymer.

9. A composition according to claim 1 wherein the copolymer (ii) has a molecular weight Mw of at least 500,000 Daltons.

10. A composition according to claim 1 in which the first monomer (A) in copolymer (ii) is maleic anhydride.

11. A process for manufacture of a detergent composition, the process comprising mixing a linear HASE copolymer formed from Monomers A, B C and D as described above with an acid precursor of an anionic surfactant and then adding alkali sufficient to neutralise the surfactant acid and to swell the copolymer.
